(19) United States
(12) Patent Application Publication
(10) Pub. No.: US 2010/0174014 A1
(43) Pub. Date: Jul. 8, 2010

(54) CROSSLINKABLE COMPOSITIONS HAVING REDUCED SCORTCH INHIBITOR MIGRATION, METHOD OF REDUCING SUCH MIGRATION, AND ARTICLES MADE THEREFROM

(76) Inventor: Robert F. Eaton, Belle Mead, NJ (US)

Correspondence Address: The Dow Chemical Company, P.O. BOX 1967, Midland, MI, 48641, US

(21) Appl. No.: 12/602,962

(22) PCT Filed: May 7, 2008
(86) PCT No.: PCT/US08/62818

§ 371 Date: Dec. 3, 2009

Related U.S. Application Data
(60) Provisional application No. 60/942,685, filed on Jun. 8, 2007.

(51) Int. Cl. C08K 5/3435; C08K 5/16

(52) U.S. Cl. 524/99; 524/186

(57) ABSTRACT

The instant invention is a crosslinkable composition having reduced scorch inhibitor migration, a method of reducing scorch inhibitor migration in a crosslinkable composition, and articles made therefrom. The crosslinkable composition comprises the melt blending reaction product of a crosslinkable polymer, a scorch inhibiting agent, and a migration inhibiting agent. The scorch inhibiting agent is a polar nitroxide, and the migration inhibiting agent is an organo clay capable of being exfoliated. The crosslinkable composition may further include a free radical initiator. The method of reducing scorch inhibitor migration in a crosslinkable composition includes the following steps: (1) selecting a crosslinkable polymer; (2) selecting a polar nitroxide scorch inhibiting agent; (3) selecting an organo clay capable of being exfoliated; (4) melt blending the scorch inhibiting agent and the organo clay into the crosslinkable polymer; (5) thereby at least partially exfoliating the organo clay into one or more high aspect ratio particles; and (6) thereby producing the crosslinkable composition having a reduced scorch inhibitor migration. The articles made according to instant invention include the crosslinking reaction product of the inventive crosslinkable composition.

### CROSS-REFERENCE TO RELATED APPLICATIONS

This application is a non-provisional application claiming priority from the U.S. Provisional Patent Application No. 60/942,685, filed on Jun. 8, 2007, entitled “CROSSLINKABLE COMPOSITIONS HAVING REDUCED SCORCH INHIBITOR MIGRATION, METHOD OF REDUCING SUCH MIGRATION, AND ARTICLES MADE THEREFROM,” the teachings of which are incorporated by reference herein, as if reproduced in full hereinbelow.

### FIELD OF INVENTION

The instant invention relates to crosslinkable compositions having reduced scorch inhibitor migration, method of reducing such migration, and articles made therefrom.

### BACKGROUND OF THE INVENTION

The use of thermally activated free radical initiators, for example, organic peroxides and azo compounds, to crosslink, that is, cure, elastomeric and thermoplastic materials is generally known. However, the use of such thermally activated free radical initiators may initiate premature crosslinking, that is, scorch, during compounding and/or processing prior to the final crosslinking step. With conventional methods of compounding, such as milling, Banbury, or extrusion, scorch occurs when the time-temperature relationship results in a condition in which the free radical initiator undergoes thermal decomposition which, in turn, initiates a crosslinking reaction that can create gel particles in the mass of the compounded polymer. These gel particles can adversely impact the processability of the compounded material as well as homogeneity of the final product.

One widely accepted method for minimizing scorch is to choose a free radical initiator that has a sufficiently high activation temperature so that compounding and/or other processing steps can be successfully completed prior to the final curing step. Typical of this class of initiators are those with a high 10-hour half-life temperature. The disadvantages of this method are longer cure times, and thus lower throughput. Higher cure temperatures can be used to offset the longer cure times, but then higher energy costs are incurred. Higher cure temperatures can also adversely affect the thermal stability of the materials.

Another method of minimizing scorch is to lower the compounding and/or processing temperature to improve the scorch safety margin of the crosslinking agent. This method, however, may have limited scope depending upon the polymer and/or process involved. In addition, curing at a lower temperature requires a longer cure time; thus, it results in lower throughput. Lower temperatures can also increase the viscosity of the material, which in turn can make mixing more difficult, and can increase the risk of running up against the freezing point of the polymer.

Yet another method of minimizing scorch is the incorporation of scorch inhibitors into the compositions. For example, British Patent No. 1,535,039 describes scorch-resistant compositions comprising organic hydroperoxides and ethylene polymers. U.S. Pat. No. 3,751,378 describes the use of N-nitroso diphenylamine or N,N′-dinitroso-para-phenylamine as scorch retardants incorporated into a polyfunctional acrylate crosslinking monomer for providing long Mooney scorch times in various elastomer formulations. U.S. Pat. No. 3,202,648 describes the use of nitrites such as isoamyl nitrite, tert-decyl nitrite and others as scorch inhibitors for polyethylene. U.S. Pat. No. 3,954,907 describes the use of monomeric vinyl compounds as protection against scorch. U.S. Pat. No. 3,335,124 describes the use of aromatic amines, phenolic compounds, mercaptothiazole compounds, bis(N,N-disubstituted-thiocarbamoyl) sulfides, hydroquinones and dialkyldithiocarbamate compounds. U.S. Pat. No. 4,632,950 describes the use of mixtures of two metal salts of disubstituted dithiocarbamic acid in which one metal salt is based on copper.

One commonly used scorch inhibitor for use in free radical, particularly peroxide, initiator-containing compositions is 4-hydroxy-2,2,6,6-tetramethylpiperidin-1-oxyl also known as 4-hydroxy-TEMPO or H-TEMPO. The addition of 4-hydroxy-TEMPO minimizes scorch by quenching free radical crosslinking of the crosslinkable polymer at melt processing temperatures. However, this nitroxide scorch inhibitor tends to be incompatible with many common polymers that are crosslinked with the help of one or more peroxide initiators. These polymers include ethylene-propylene-diene monomer (EPDM), low density polyethylene (LDPE), linear low density polyethylene (LLDPE), high density polyethylene (HDPE), ethylene vinyl acetate (EVA) comprising less than about 10 percent by weight of vinyl acetate content, unsaturated acrylates, for example, methyl, ethyl or butyl acrylate comprising less than about 10 percent by weight of acrylate content, and the like. As a result of this incompatibility, 4-hydroxy-TEMPO tends to migrate to the surface of a pelleted or sheeted product and can cause handling issues such as dusting, segregation, stickiness and the like. In addition, the product can lose its scorch inhibition efficiency over time, and thus its shelf-life can be compromised. This migration problem usually manifests itself when the nitroxide is blended with the polymer to make a concentrate or masterbatch, and it can also limit the concentration of the nitroxide in a fully formulated product.

It is generally known that filers may impede additive migration by increasing diffusant tortuacity. For example, amorphous silica may reduce additive migration up to 33 percent. However, higher level of reduction in additive migration is desired.

Despite the research efforts in developing crosslinkable compositions with reduced scorch inhibitor migration, there is still a need for a crosslinkable composition having reduced scorch inhibitor migration; furthermore, there is still a need for a method of reducing scorch inhibitor migration.

### SUMMARY OF THE INVENTION

The instant invention is a crosslinkable composition having reduced scorch inhibitor migration, a method of reducing scorch inhibitor migration in a crosslinkable composition, and articles made therefrom. The crosslinkable composition comprises the melt blending reaction product of a crosslinkable polymer, a scorch inhibiting agent, and a migration inhibiting agent. The scorch inhibiting agent is a polar nitroxide, and the migration inhibiting agent is an organo clay capable of being exfoliated. The crosslinkable composition may further include a free radical initiator. The method of reducing scorch inhibitor migration in a crosslinkable composition includes the following steps: (1) selecting a crosslinkable polymer; (2) selecting a polar nitroxide scorch inhibiting agent; (3) selecting an organo clay capable of being exfoliated; (4) melt blending the scorch inhibiting agent and the organo clay into the crosslinkable polymer; (5) thereby at least partially exfoliating the organo clay into one or more high aspect ratio particles; and (6) thereby producing the crosslinkable composition having a reduced scorch inhibitor migration. The articles made according to instant invention include the crosslinking reaction product of the inventive crosslinkable composition.

In one embodiment, the instant invention provides a crosslinkable composition comprising the melt blending reaction product of a crosslinkable polymer, a polar nitroxide scorch inhibiting agent, an organo clay capable of being exfoliated, and optionally a free radical initiator.

In an alternative embodiment, the instant invention further provides a method of producing a crosslinkable composition comprising the following steps: (1) selecting a crosslinkable polymer; (2) selecting a polar nitroxide scorch inhibiting agent; (3) selecting an organo clay capable of being exfoliated; (4) optionally selecting a free radical initiator; (5) melt blending the polar scorch inhibiting agent, the organo clay, and the optional free radical initiator, into the crosslinkable polymer; (6) thereby at least partially exfoliating the organo clay into one or more high aspect ratio particles; and (7) thereby producing the crosslinkable composition having a reduced scorch inhibitor migration.

In an alternative embodiment, the instant invention further provides a method of reducing scorch inhibitor migration in a crosslinkable composition comprising the following steps: (1) selecting a crosslinkable polymer; (2) selecting a polar nitroxide scorch inhibiting agent; (3) selecting an organo clay capable of being exfoliated; (4) optionally selecting a free radical initiator; (5) melt blending the polar scorch inhibiting agent, the organo clay, and the optional free radical initiator, into the crosslinkable polymer; (6) thereby at least partially exfoliating the organo clay into one or more high aspect ratio particles; and (7) thereby producing the crosslinkable composition having a reduced scorch inhibitor migration.

In another alternative embodiment, the instant invention further provides an article comprising the crosslinking reaction product of the inventive crosslinkable composition.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the crosslinkable polymer being selected from the group consisting of low density polyethylene (LDPE), linear low density polyethylene (LLDPE), high density polyethylene (HDPE), medium density polyethylene (MDPE), ultra-low density polyethylene, chlorinated polyethylene, polypropylene, ethylene propylene copolymer, ethylene-propylene terpolymer, ethylene-propylene-diene monomer (EPDM), ethylene vinyl acetate (EVA), polybutadiene, styrene-acrylonitrile (SAN), acrylonitrile-butadiene-styrene (ABS), silicone rubber, chlorosulfonated polyethylene, fluoroelastomers and combinations thereof.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the free radical initiator being a peroxide.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the peroxide being an organic peroxide selected from the group consisting of dialkyl peroxides, diacyl peroxides, and perketals.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the polar nitroxide scorch inhibiting agent being selected from the group consisting of 4-hydroxy-2,2,6,6-tetramethylpiperidin-1-oxyl (4-hydroxy-TEMPO), 4-oxo-2,2,6,6,tetramethylpiperidine-N-oxyl (4-oxo-Tempo), derivatives thereof, and combinations thereof.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the organo clay having at least 2 fatty acid substitutions.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the crosslinkable composition comprising from 60 to 98 percent by weight of the crosslinkable polymer, based on the weight of said crosslinkable composition.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the crosslinkable composition comprising from 1 to 10 percent by weight of the polar nitroxide scorch inhibiting agent, based on the weight of said crosslinkable composition.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the crosslinkable composition comprising from 1 to 10 percent by weight of the organo clay, based on the weight of said crosslinkable composition.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the crosslinkable composition comprising from 60 to 98 percent by weight of the crosslinkable polymer, optionally from 0 to 20 percent by weight of the free radical initiator, from 1 to 10 percent by weight of the polar scorch inhibiting agent, and from 1 to 10 percent by weight of the organo clay, based on the weight of the crosslinkable composition.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the organo clay comprising one or more high aspect ratio organo clay particles.

In an alternative embodiment, the instant invention provides a crosslinkable composition, a method of producing a crosslinkable composition, a method of reducing scorch inhibitor migration in a crosslinkable composition, and articles made therefrom, in accordance with any of the preceding embodiments, except that the crosslinkable composition is a masterbatch to be blended with other polymers, and/or additives such as fillers, antioxidants, stabilizers, plasticizers, processing oils, peroxides, and the like.

### BRIEF DESCRIPTION OF THE DRAWINGS

For the purpose of illustrating the invention, there is shown in the drawings a form that is exemplary; it being understood, however, that this invention is not limited to the precise arrangements and instrumentalities shown.

FIG. 1 is a first graph illustrating the relationship between scorch inhibitor migration, and the type and concentration of clay being used;

FIG. 2 is a first graph illustrating the relationship between scorch inhibitor migration, and the type and concentration of clay being used;

FIG. 3 is a transmission electron micrograph of an inventive crosslinkable composition comprising 5 percent by weight of exfoliated Cloisite® 15a, 5 percent by weight of H-TEMPO, and 90 percent by weight of Nordel® 3722; and

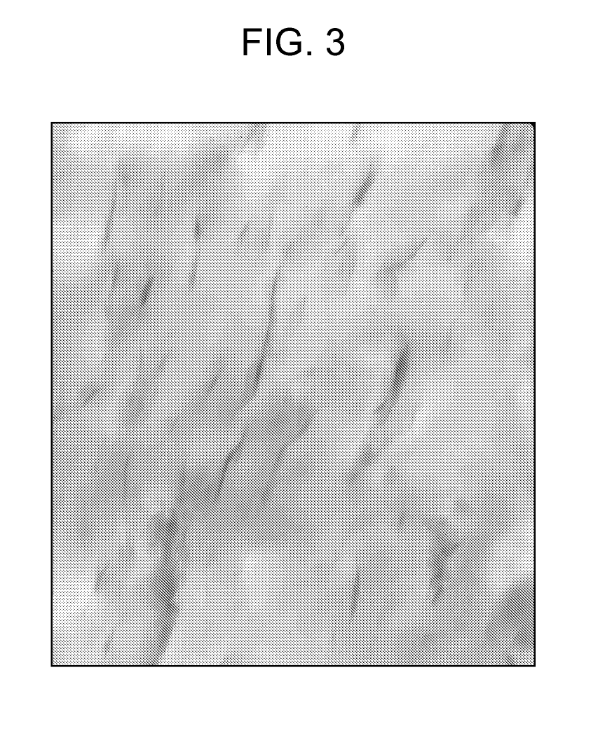

FIG. 4 is a transmission electron micrograph of an inventive crosslinkable composition comprising 2.5 percent by weight of exfoliated Cloisite® 15a, 5 percent by weight of H-TEMPO, and 92.5 percent by weight of Nordel® 3722.

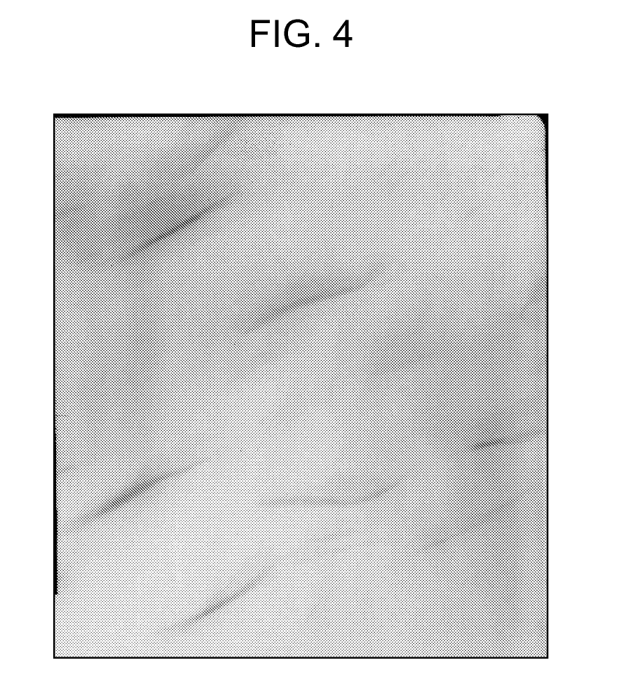

### DETAILED DESCRIPTION OF THE INVENTION

The instant invention is a crosslinkable composition having reduced scorch inhibitor migration, a method of reducing scorch inhibitor migration in a crosslinkable composition, and articles made therefrom. The crosslinkable composition comprises the melt blending reaction product of a crosslinkable polymer, a scorch inhibiting agent, and a migration inhibiting agent. The scorch inhibiting agent is polar, and the migration inhibiting agent is an organo clay capable of being exfoliated. The crosslinkable composition may further include a free radical initiator. The method of reducing scorch inhibitor migration in a crosslinkable composition includes the following steps: (1) selecting a crosslinkable polymer; (2) selecting a polar nitroxide scorch inhibiting agent; (3) selecting an organo clay capable of being exfoliated; (4) melt blending the scorch inhibiting agent and the organo clay into the crosslinkable polymer; (5) thereby at least partially exfoliating the organo clay into high aspect ratio particles; and (6) thereby producing the crosslinkable composition having a reduced scorch inhibitor migration. The articles according to instant invention include the crosslinking reaction product of the inventive crosslinkable composition.

The crosslinkable polymer is, for example, be a hydrocarbon-based polymer. Exemplary hydrocarbon-based polymers include, but are not limited to, ethylene/propylene/diene monomers, ethylene/propylene rubbers, ethylene/alpha-olefin copolymers, ethylene homopolymers, propylene homopolymers, ethylene/styrene interpolymers, ethylene/unsaturated ester copolymers, halogenated polyethylenes, propylene copolymers, natural rubber, styrene/butadiene rubber, styrene/butadiene/styrene block copolymers, styrene/ethylene/butadiene/styrene copolymers, polybutadiene rubber, butyl rubber, chloroprene rubber, chlorosulfonated polyethylene rubber, ethylene/diene copolymer, and nitrile rubber, and blends thereof. Preferably, the crosslinkable polymer is an olefin-based polymer. The crosslinkable polymer is, for example, selected from the group consisting of low density polyethylene (LDPE), linear low density polyethylene (LLDPE), high density polyethylene (HDPE), medium density polyethylene (MDPE), ultra-low density polyethylene, chlorinated polyethylene, polypropylene, ethylene propylene copolymer, ethylene-propylene terpolymer, ethylene-propylene-diene monomer (EPDM), ethylene vinyl acetate (EVA), polybutadiene, styrene-acrylonitrile (SAN), acrylonitrile-butadiene-styrene (ABS), silicone rubber, chlorosulfonated polyethylene, fluoroelastomers and combinations thereof.

With regard to the suitable ethylene polymers, the crosslinkable polymers generally fall into four main classifications: (1) highly-branched; (2) heterogeneous linear; (3) homogeneously branched linear; and (4) homogeneously branched substantially linear. These polymers can be prepared with Ziegler-Natta catalysts, metallocene or vanadium-based single-site catalysts, or constrained geometry single-site catalysts.

Highly branched ethylene polymers include low density polyethylene (LDPE). Those polymers can be prepared with a free-radical initiator at high temperatures and high pressure. Alternatively, they can be prepared with a coordination catalyst at high temperatures and relatively low pressures. These polymers have a density in the range of 0.910 to 0.940 g/cm³.

Heterogeneous linear ethylene polymers include linear low density polyethylene (LLDPE), ultra-low density polyethylene (ULDPE), very low density polyethylene (VLDPE), and high density polyethylene (HDPE). Linear low density ethylene polymers have a density in the range of 0.850 to 0.940 g/cm³, and a melt index (I₂) in the range of 0.01 to 100 g/10 minutes. Preferably, the melt index (I₂) is between 0.1 to 50 g/10 minutes. Also, preferably, the LLDPE is an interpolymer of ethylene and one or more other alpha-olefins having from 3 to 18 carbon atoms, more preferably from 3 to 8 carbon atoms. Preferred comonomers include, but are not limited to, 1-butene, 4-methyl-1-pentene, 1-hexene, and 1-octene.

Ultra-low density polyethylene and very low density polyethylene are known interchangeably. These polymers have a density in the range of 0.870 to 0.910 g/cm³. High density ethylene polymers are generally homopolymers with a density in the range of 0.941 to 0.965 g/cm³.

Homogeneously branched linear ethylene polymers include homogeneous LLDPE. The uniformly branched/homogeneous polymers are those polymers in which the comonomer is randomly distributed within a given interpolymer molecule and wherein the interpolymer molecules have a similar ethylene/comonomer ratio within that interpolymer.

Homogeneously-branched substantially linear ethylene polymers include (a) homopolymers of C₂-C₂₀ olefins, such as ethylene, propylene, and 4-methyl-1-pentene, (b) interpolymers of ethylene with at least one C₃-C₂₀ alpha-olefin, C₂-C₂₀ acetylenically unsaturated monomer, C₄-C₁₈ diolefin, or combinations of the monomers, and (c) interpolymers of ethylene with at least one of the C₃-C₂₀ alpha-olefins, diolefins, or acetylenically unsaturated monomers in combination with other unsaturated monomers. These polymers generally have a density in the range of 0.850 to 0.970 g/cm³. Preferably, the density is in the range of 0.850 to 0.955 g/cm³, more preferably, in the range of 0.850 to 0.920 g/cm³.

Exemplary ethylene/styrene interpolymers include, but are note limited to, substantially random interpolymers prepared by polymerizing an olefin monomer (that is, ethylene, propylene, or alpha-olefin monomer) with a vinylidene aromatic monomer, hindered aliphatic vinylidene monomer, or cycloaliphatic vinylidene monomer. Suitable olefin monomers contain from 2 to 20, preferably from 2 to 12, more preferably from 2 to 8 carbon atoms. Preferred such monomers include ethylene, propylene, 1-butene, 4-methyl-1-pentene, 1-hexene, and 1-octene. Most preferred are ethylene and a combination of ethylene with propylene or C₄₋₈ alpha-olefins. Optionally, the ethylene/styrene interpolymers polymerization components can also include ethylenically unsaturated monomers such as strained ring olefins. Examples of strained ring olefins include, but are not limited to, norbornene and C₁₋₁₀ alkyl- or C₆₋₁₀ aryl-substituted norbornenes.

Exemplary ethylene/unsaturated ester copolymers useful in the present invention can be prepared by conventional high-pressure techniques. The unsaturated esters can, for example, be alkyl acrylates, alkyl methacrylates, or vinyl carboxylates. The alkyl groups can have 1 to 8 carbon atoms, and preferably have 1 to 4 carbon atoms. The carboxylate groups can have 2 to 8 carbon atoms, and preferably have 2 to 5 carbon atoms. The portion of the copolymer attributed to the ester comonomer can be in the range of 5 to 50 percent by weight based on the weight of the copolymer, and is preferably in the range of 15 to 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. The melt index of the ethylene/unsaturated ester copolymers can be in the range of 0.5 to 50 g/10 minutes.

Exemplary halogenated ethylene polymers useful in the present invention include, but are not limited to, fluorinated, chlorinated, and brominated olefin polymers. The base olefin polymer can be a homopolymer or an interpolymer of olefins having from 2 to 18 carbon atoms. Preferably, the olefin polymer will be an interpolymer of ethylene with propylene or an alpha-olefin monomer having 4 to 8 carbon atoms. Preferred alpha-olefin comonomers include, but are note limited to, 1-butene, 4-methyl-1-pentene, 1-hexene, and 1-octene. Preferably, the halogenated olefin polymer is a chlorinated polyethylene.

Examples of propylene polymers useful in the present invention include, but are note limited to, propylene homopolymers and copolymers of propylene with ethylene or another unsaturated comonomer. Copolymers also include terpolymers, tetrapolymers, and the like. Typically, the polypropylene copolymers comprise units derived from propylene in an amount of at least about 60 weight percent, based on the weight of the copolymer. Preferably, the propylene monomer is at least about 70 weight percent of the copolymer, more preferably at least about 80 weight percent.

Natural rubbers suitable in the present invention include, but are note limited to, high molecular weight polymers of isoprene. Preferably, the natural rubber will have a number average degree of polymerization of about 5000 and a broad molecular weight distribution.

Useful styrene/butadiene rubbers include, but are not limited to, random copolymers of styrene and butadiene. Typically, these rubbers are produced by free radical polymerization. Styrene/butadiene/styrene block copolymers of the present invention may, for example, be a phase-separated system. The styrene/ethylene/butadiene/styrene copolymers useful in the present invention may, for example, be prepared from the hydrogenation of styrene/butadiene/styrene copolymers.

The polybutadiene rubber useful in the present invention is preferably a homopolymer of 1,4-butadiene. Preferably, the butyl rubber useful in the present invention is a copolymer of isobutylene and isoprene. The isoprene is typically used in an amount in the range of 1.0 to 3.0 weight percent, based on the weight of the copolymer.

For the present invention, polychloroprene rubbers are generally polymers of 2-chloro-1,3-butadine. Preferably, the rubber is produced by an emulsion polymerization. Additionally, the polymerization can occur in the presence of sulfur to incorporate crosslinking in the polymer.

Preferably, the nitrile rubber useful in the present invention is a random copolymer of butadiene and acrylonitrile.

Other useful crosslinkable polymers include, but are note limited to, silicone rubbers and fluorocarbon rubbers. Silicone rubbers include, but are note limited to, rubbers with a siloxane backbone of the form —Si—O—Si—O—. Fluorocarbon rubbers useful in the present invention include, but are note limited to, copolymers or terpolymers of vinylidene fluoride, hexafluoropropylene, and tetrafluoroethylene with a cure site monomer to permit free-radical crosslinking.

The crosslinkable polymer may, for example, be selected from the group consisting of low density polyethylene (LDPE), linear low density polyethylene (LLDPE), high density polyethylene (HDPE), medium density polyethylene (MDPE), ultra-low density polyethylene, chlorinated polyethylene, polypropylene, ethylene propylene copolymer, ethylene-propylene terpolymer, ethylene-propylene-diene monomer (EPDM), ethylene vinyl acetate (EVA), polybutadiene, styrene-acrylonitrile (SAN), acrylonitrile-butadiene-styrene (ABS), silicone rubber, chlorosulfonated polyethylene, fluoroelastomers and combinations thereof.

The crosslinkable composition comprises less than 99 percent by weight of the crosslinkable polymer, based on the weight the crosslinkable composition. All individual values and subranges less than 99 weight percent are included herein and disclosed herein; for example, the crosslinkable composition may comprise from 60 to 98 percent by weight of the crosslinkable polymer, based on the weight the crosslinkable composition; or in the alternative, the crosslinkable composition may comprise from 80 to 98 percent by weight of the crosslinkable polymer, based on the weight the crosslinkable composition.

The scorch inhibitor useful in the present invention is, for example, a polar nitroxide scorch inhibiting agent. Exemplary polar nitroxide scorch inhibitors include, but are not limited to, 4-hydroxy-2,2,6,6-tetramethylpiperidin-1-oxyl (4-hydroxy-TEMPO), 4-oxo-2,2,6,6,tetramethylpiperidine-N-oxyl (4-oxo-Tempo), derivatives thereof, and combinations thereof. The crosslinkable composition may, for example, comprise from 0.5 to 10 percent by weight of the scorch inhibitor, based on the weight of the crosslinkable composition. All individual values and subranges from 0.5 to 10 weight percent are included herein and disclosed herein; for example, the crosslinkable composition may comprise from 0.5 to 7 percent by weight of the scorch inhibitor, based on the weight the crosslinkable composition; or in the alternative, the crosslinkable composition may comprise from 0.5 to 5 percent by weight of the scorch inhibitor, based on the weight the crosslinkable composition; or in the alternative, the crosslinkable composition may comprise from 2 to 5 percent by weight of the scorch inhibitor, based on the weight the crosslinkable composition.

The migration inhibiting agent may, for example, be an organo clay. Organo clay may, for example, be an orgnophillic cation modified clay derived from a clay mineral, generally of the smectite group, for example bentonite, montmorillonite, hetorite, saponite, or the like, by replacing the inorganic exchangeable cations, generally alkai or alkaline earth metal cations, which occur in the natural clay mineral by organic cations each comprising at least one hydrocarbon radical which has sufficient carbon atoms to render the surface of the cat-ion exchanged clay hydrophobic. The Organo clay particles may, for example, be crystalline materials with a sandwich structure composed of stacked platelets with a thickness of less than 2 nm, preferably less than 1 nm, and a diameter of 10 to 1000 nm. The spacing between the platelets may, for example, be less than 1 nm. The organo clay component is capable of being exfoliated, that is, the organo clay particles are at least partially or fully separated or delaminated and dispersed in the polymer matrix, that is, the crosslinkable polymer. The exfoliated or delaminated platelets may be spaced a part from each other a distance in the range of 10 to 500 nanometers. The exfoliated or delimited platelets may be high aspect ratio particles, that is, the exfoliated or delaminated platelets have a surface area/thickness ratio in the range of equal or greater than 10:1; or in the alternative, the exfoliated or delaminated platelets have a surface area/thickness ratio in the range of equal or greater than 10:1 to 20:1. The crosslinkable composition may, for example, comprise from 0.5 to 10 percent by weight of the organo clay, based on the weight of the crosslinkable composition. All individual values and subranges from 0.5 to 10 weight percent are included herein and disclosed herein; for example, the crosslinkable composition may comprise from 0.5 to 7 percent by weight of the organo clay, based on the weight the crosslinkable composition; or in the alternative, the crosslinkable composition may comprise from 0.5 to 5 percent by weight of the organo clay, based on the weight the crosslinkable composition; or in the alternative, the crosslinkable composition may comprise from 2 to 5 percent by weight of the organo clay, based on the weight the crosslinkable composition. Such organo clay are commercially available under the tradename Cloisite 15a from Southern Clay Products Inc. Texas, USA.

The free radical initiators used in the practice of this invention include any thermally activated compound that is relatively unstable and easily breaks into at least two radicals. Representative of this class of compounds include, but are not limited to, peroxides, particularly the organic peroxides, and the azo initiators. Exemplary free radical initiators used as cros slinking agents include, but are not limited to, dialkyl peroxides, diacyl peroxide, and diperoxyketal initiators.

In the group of dialkyl peroxides, the exemplary initiators includes, but are not limited to, dicumyl peroxide; di-tert-butyl peroxide; tert-butylcumyl peroxide; 2,5-dimethyl-2,5-di(tert-butylperoxy)-hexane; 2,5-dimethyl-2,5-di(tert-amylperoxy)-hexane; 2,5-dimethyl-2,5-di(t-butylperoxy)hexyne-3; 2,5-dimethyl-2,5-di(tert-amylperoxy)hexyne-3; α,α-di[(tert-butylperoxy)-isopropyl]-benzene; di-tert-amyl peroxide; 1,3,5-tri-[(tert-butylperoxy)-isopropyl]benzene; 1,3-dimethyl-3-(tert-butylperoxy)butanol; 1,3-dimethyl-3-(tert-amylperoxy)butanol; and mixtures of two or more of these initiators.

In the group of diperoxyketal initiators, the exemplary initiators includes, but are not limited to, 1,1-di(tert-butylperoxy)-3,3,5-trimethylcyclohexane; 1,1-di(tert-butylperoxy)cyclohexane; n-butyl 4,4-di(tert-amylperoxy)valerate; ethyl 3,3-di(tert-butylperoxy)butyrate; 2,2-di(tert-amylperoxy)propane; 3,6,6,9,9-pentamethyl-3-ethoxycarbonylmethyl-1,2,4,5-tetraoxacyclononane; n-butyl-4,4-bis(t-butylperoxy)-valerate; ethyl-3,3-di(t-amylperoxy)-butyrate; and mixtures of two or more of these initiators.

In the group of diacyl peroxide initiators, the exemplary initiators include, but are not limited to, diacyperoxide.

Exemplary azo initiators include, but are not limited to, 2,2′-azobis-(2-acetoxypropane). Other suitable azo initiators include those described in the U.S. Pat. Nos. 3,862,107 and 4,129,531. Mixtures of two or more free radical initiators may also be used together as the initiator within the scope of this invention. In addition, free radicals can form from shear energy, heat or radiation.

The crosslinkable composition may, for example, comprise from 0.1 to 20 percent by weight of the free radical initiator, based on the weight the crosslinkable composition. All individual values and subranges from 0.1 to 20 weight percent are included herein and disclosed herein; for example, the crosslinkable composition may comprise from 0.5 to 10 percent by weight of the free radical initiator, based on the weight the crosslinkable composition; or in the alternative, the crosslinkable composition may comprise from 0.5 to 5 percent by weight of the free radical initiator, based on the weight the crosslinkable composition; or in the alternative, the crosslinkable composition may comprise from 0.5 to 2 percent by weight of the free radical initiator, based on the weight the crosslinkable composition.

In addition, blends of two or more crosslinkable polymers, as described herein above, may be employed. The crosslinkable compositions may further contain various other additives known to those skilled in the art including, but not limited to, fillers such as carbon black, titanium dioxide, and the alkaline earth metal carbonates, and monomeric co-agents such as triallylcyanurate, allyldiglycolcarbonate, triallylisocyanurate, trimethylolpropane, diallylether, trimethylolpropane trimethacrylate, and various allylic compounds. Methacrylate and acrylate compounds may also be added separately to the various crosslinkable polymers identified above. The crosslinkable compositions of this invention may also contain such conventional additives as antioxidants, stabilizers, plasticizers, processing oils and the like.

The scorch inhibitor, the migration inhibiting agent, and optionally the free radical initiator are admixed in polymer matrix, that is, crosslinkable polymer, by employing conventional compounding means including, but not limited to, spraying, soaking, and melt compounding. The scorch inhibitor, the migration inhibiting agent, and optionally the free radical initiator are, for example, admixed in polymer matrix, that is, crosslinkable polymer, via melt compounding. The scorch inhibitor can be blended into the crosslinkable polymer directly or formulated with one or more other components, that is, migration inhibiting agent or free radical initiator, and then, blended into the crosslinkable polymer matrix. In one preferred embodiment, the scorch inhibitor, the migration inhibiting agent, and optionally the free radical initiator are formulated with the crosslinkable polymer to form a masterbatch, and then this masterbatch is melt blended with the remainder of the polymer to form a homogeneous composition. The melt compounding process may be continuous or batch.

In a melt blending process, the scorch inhibitor and the migration inhibiting agent may be melt blended and dispersed in the polymer matrix, that is, the crosslinkable polymer via any conventional methods. For example, the scorch inhibitor and the migration inhibiting agent may be melt blended and dispersed in the polymer matrix via an extruder, for example, single screw extruder or twin screw extruder, Barbender mixer, Banbury mixer, and the like. The melt blending process may have residence time in the range of at least 5 seconds, for example, the melt blending process may have residence time in the range of 1 minute to 20 minutes; or in the alternative, the melt blending process may have residence time in the range of 4 to 20 minutes.

In an alternative melt blending process, the scorch inhibitor, the migration inhibiting agent, and optionally the free radical initiator may be melt blended and dispersed in the polymer matrix, that is, the crosslinkable polymer via any conventional methods. For example, the scorch inhibitor, the migration inhibiting agent, and optionally the free radical initiator may be melt blended and dispersed in the polymer matrix via an extruder, for example, single screw extruder or twin screw extruder, Barbender mixer, Banbury mixer, and the like. The melt blending process may have residence time in the range of at least 5 seconds, for example, the melt blending process may have residence time in the range of 1 minute to 20 minutes; or in the alternative, the melt blending process may have residence time in the range of 4 to 20 minutes.

The crosslinkable composition according to instant invention may be used in a variety of different applications. Exemplary applications include, but are not limited to, wire cable jackets, shoe components, hose and tubes, belts, and flooring. Different conventional methods may be employed to transform the inventive crosslinkable composition into different articles. Such methods include, but are not limited to, extrusion, molding, slot casting, film extrusion, and the like.

### EXAMPLES

The following examples illustrate the present invention but are not intended to limit the scope of the invention. The examples of the instant invention demonstrate that the use of nitroxide scorch inhibitor such as H-TEMPO and amines precursors thereof in a crosslinkable polymer composition to exfoliate organo clay reduces migration of scorch inhibitor out of the crosslinkable polymer and improves mechanical properties of the crosslinkable composition.

Formulation components include the followings:

Nordel™ 3722, commercially available from The Dow Chemical Company, is a semi-crystalline polymer composition comprising 70.5 percent by weight of ethylene (ASTM-D 3900), 29 percent by weight of propylene(ASTM-D 3900), and 0.5 percent by weight of ethylidenenorbronene(ASTM-D 6047), and a density of about 0.87 g/cm³(ASTM-D 297).

Nordel™ 4640, commercially available from The Dow Chemical Company, is a semi-amorphous ethylene-propylene-diene terpolymer (EPDM) comprising 55 percent by weight of ethylene (ASTM-D 3900), 40 percent by weight of propylene(ASTM-D 3900), and 5.0 percent by weight of ethylidenenorbronene(ASTM-D 6047), and a density of about 0.86 g/cm³(ASTM-D 297).

H-TEMPO is 4_hydroxy-2,2,6,6-tetramethylpiperidine 1-oxyl, CAS No. 2226-96-2, which is commercially available from AH Marks and Company Limited, England.

Cloisite® 15a is an alkyl quaternary bentonite, CAS No. 68953-58-2, which is commercially available from Southern Clay Products, Inc., Texas.

Cloisite® 30b is an alkyl quaternary ammonium bentonite, CAS No. 341537-63-1, which is commercially available from Southern Clay Products, Inc., Texas.

Cloisite® NA⁺ is a hydrated aluminum silicate, montmorillonite, CAS No. 1318-93-0, which is commercially available from Southern Clay Products, Inc., Texas.

### Inventive Example 1

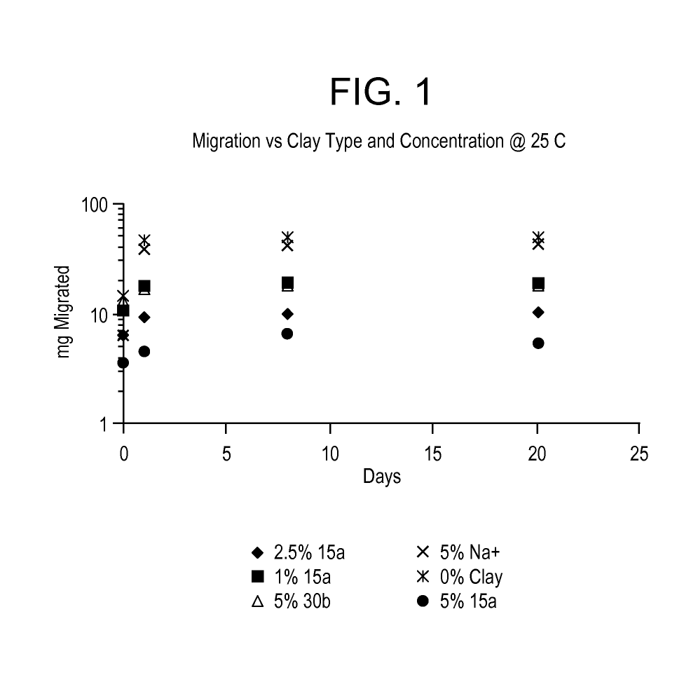

Inventive Example 1 was prepared according to the following procedure. The formulation for Inventive Example 1 is shown in Table I. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Inventive Example 1 was determined, and the results are shown in FIG. 1.

### Inventive Example 2

Inventive Example 2 was prepared according to the following procedure. The formulation for Inventive Example 2 is shown in Table I. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Inventive Example 2 was determined, and the results are shown in FIG. 1.

### Inventive Example 3

Inventive Example 3 was prepared according to the following procedure. The formulation for Inventive Example 3 is shown in Table I. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Inventive Example 3 was determined, and the results are shown in FIG. 1.

### Comparative Example A

Comparative Example A was prepared according to the following procedure. The formulation for Comparative Example A is shown in Table I. The crosslinkable polymer pellets were loaded into a Barbender mixer, and mixed at 20 to 50 rpm and an initial temperature in the range of 80 to 120° C. until molten. The scorch inhibitor was added and further mixed at the same temperature and speed. The migration of scorch inhibitor for Comparative Example A was determined, and the results are shown in FIG. 1.

### Comparative Example B

Comparative Example B was prepared according to the following procedure. The formulation for Comparative Example B is shown in Table I. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Comparative Example B was determined, and the results are shown in FIG. 1.

### Comparative Example C

Comparative Example C was prepared according to the following procedure. The formulation for Comparative Example C is shown in Table I. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Comparative Example C was determined, and the results are shown in FIG. 1.

### Inventive Example 4

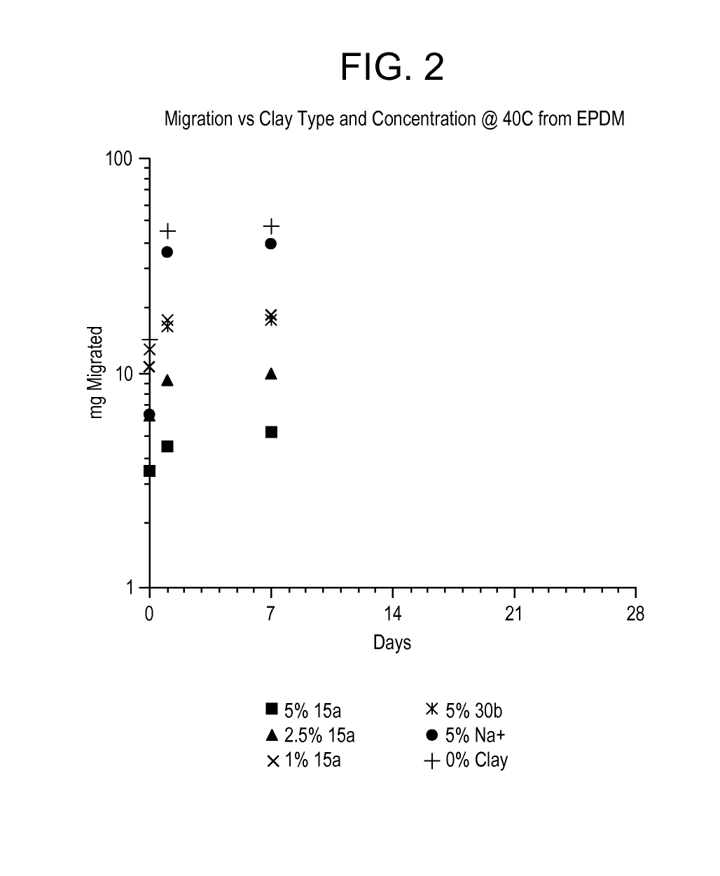

Inventive Example 4 was prepared according to the following procedure. The formulation for Inventive Example 4 is shown in Table 2. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Inventive Example 4 was determined, and the results are shown in FIG. 2.

### Inventive Example 5

Inventive Example 5 was prepared according to the following procedure. The formulation for Inventive Example 5 is shown in Table II. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Inventive Example 5 was determined, and the results are shown in FIG. 2.

### Inventive Example 6

Inventive Example 6 was prepared according to the following procedure. The formulation for Inventive Example 6 is shown in Table II. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Inventive Example 6 was determined, and the results are shown in FIG. 2.

### Comparative Example D

Comparative Example D was prepared according to the following procedure. The formulation for Comparative Example D is shown in Table II. The crosslinkable polymer pellets were loaded into a Barbender mixer, and mixed at 20 to 50 rpm and an initial temperature in the range of 80 to 120° C. until molten. The scorch inhibitor was added and further mixed at the same temperature and speed. The migration of scorch inhibitor for Comparative Example D was determined, and the results are shown in FIG. 2.

### Comparative Example E

Comparative Example E was prepared according to the following procedure. The formulation for Comparative Example E is shown in Table II. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Comparative Example E was determined, and the results are shown in FIG. 2.

### Comparative Example F

Comparative Example F was prepared according to the following procedure. The formulation for Comparative Example F is shown in Table II. The crosslinkable polymer pellets were loaded into a Barbender mixer, and mixed at 20 to 50 rpm and an initial temperature in the range of 80 to 120° C. until molten. The scorch inhibitor and the migration inhibitor were added and further mixed at the same temperature and speed. The migration of scorch inhibitor for Comparative Example F was determined, and the results are shown in FIG. 2.

### Test Methods

Test methods include the following:

Scorch inhibitor migration was determined according to the following procedure. A plaque having dimensions of 89 mm×44 mm×4 mm, surface area of 89 cm², with a weight of ˜13 g was prepared. The plaque's surface is then washed with HPLC grade water or acetonitrile (ACN). HPLC is employed to determine the level of TEMPO compound formation. The plaque sample is placed in an empty 200 ml crystallization dish. The 200 ml crystallization dish is filled with ABOUT 70 mL HPLC grade water or ACN. The plaque is washed by immersing it entirely in the solvent. The solution is transferred into a 100 ml volumetric flask. Additional solvent is added to increase the volume of the solution to 100 ml. HPLC is run on this solution employing the appropriate TEMPO method, for example, TEMPO-W.m, to determine quantity migrated. The conditions for the HPLC analysis is shown below.

HPLC condition:

| Instrument: | Agilent 1100 Series | |
|---|---|---|
| Method: | TEMPO-W.m | |
| Mobile phase: | H2O/ACN | |
| Column: | AquaSil C-18; 2.1 × 100 mm, 5 um, (no guard column) | |
| Gradient: | Time (min) | % B |
| | 0 | 50 |
| | 3 | 50 |
| | 5 | 100 |
| | 8 | 100 |
| | 10 | 50 |
| | 15 | 50 |

| | |
|---|---|
| Total run time: | 25 min. |
| Post Time: | 10 min |
| Signal: | 240 nm, 16; ref: 360, 40 |
| Flow: | 0.30 ml/min |
| Oven Temp.: | 40° C. |
| Injection: | 5 μl |

Scorch was measured according to the following procedure. The resin is first loaded into a lab scale (45 grams) Barbender mixer, then the other additives, for example, peroxide, are added and mixed for 5 minutes at 35 rpm, 90° C. The mixture is then removed and pressed into a sheet before cooling down. Samples are cut from the sheets prepared in the previous step, and placed into the rheometer, for example, MDR 2000 from Alpha Technologies (ASTM-D5289), chamber for cure performance analysis. The MDR 2000 is run at 140° C. for 30 minutes and both Ts 0.1 and Ts 1 were obtained to determine scorch inhibition characteristics. Ts 0.1 is the time for the measured torque to rise 0.1 foot pound above the initial torque of the polymer. Similarly Ts 1 is the time for the torque to rise 1 foot pound above the initial torque of the polymer. The Ts values are measures of the induction time, time for noticeable crosslinking of the polymer to be observed by increase torque.

The present invention may be embodied in other forms without departing from the spirit and the essential attributes thereof, and, accordingly, reference should be made to the appended claims, rather than to the foregoing specification, as indicating the scope of the invention.

TABLE I

| | | Inventive | Inventive | Inventive | Comparative | Comparative | Comparative |
|---|---|---|---|---|---|---|---|
| | Units | Example 1 | Example 2 | Example 3 | Example A | Example B | Example C |
| Nordel ™ 3722 | Weight Percent | 94 | 92.5 | 90 | 90 | 90 | 90 |
| H-TEMPO | Weight Percent | 5 | 5 | 5 | 5 | 5 | 5 |
| Cloisite ® 15a | Weight Percent | 1 | 2.5 | 5 | None | None | None |
| Cloisite ® 30b | Weight Percent | None | None | None | None | 5 | None |
| Cloisite ® Na⁺ | Weight Percent | None | None | None | None | None | 5 |

TABLE II

| | | Inventive | Inventive | Inventive | Comparative | Comparative | Comparative |
|---|---|---|---|---|---|---|---|
| | Units | Example 4 | Example 5 | Example 6 | Example D | Example E | Example F |
| Nordel ™ 4640 | Weight Percent | 94 | 92.5 | 90 | 90 | 90 | 90 |
| H-TEMPO | Weight Percent | 5 | 5 | 5 | 5 | 5 | 5 |
| Cloisite ® 15a | Weight Percent | 1 | 2.5 | 5 | None | None | None |
| Cloisite ® 30b | Weight Percent | None | None | None | None | 5 | None |
| Cloisite ® Na⁺ | Weight Percent | None | None | None | None | None | 5 |

We claim:

1. A crosslinkable composition comprising the melt blending reaction product of:
a crosslinkable polymer;
a scorch inhibiting agent, wherein said scorch inhibiting agent being a polar nitroxide; and
a migration inhibiting agent, wherein said migration inhibiting agent being an organo clay capable of being exfoliated.

2. The crosslinkable composition according to claim 1, wherein said crosslinkable polymer being selected from the group consisting of low density polyethylene (LDPE), linear low density polyethylene (LLDPE), high density polyethylene (HDPE), medium density polyethylene (MDPE), ultra-low density polyethylene, chlorinated polyethylene, polypropylene, ethylene propylene copolymer, ethylene-propylene terpolymer, ethylene-propylene-diene monomer (EPDM), ethylene vinyl acetate (EVA), polybutadiene, styrene-acrylonitrile (SAN), acrylonitrile-butadiene-styrene (ABS), silicone rubber, chlorosulfonated polyethylene, fluoroelastomers and combinations thereof.

3. The crosslinkable composition according to claim 1, wherein said polar scorch inhibiting agent being selected from the group consisting of 4-hydroxy-2,2,6,6-tetramethylpiperidin-1-oxyl (4-hydroxy-TEMPO), and 4-oxo-2,2,6,6,tetramethylpiperidine-N-oxyl (4-oxo-Tempo).

4. The crosslinkable composition according to claim 1, wherein said organo clay having at least 2 fatty acids substitutions.

5. The crosslinkable composition according to claim 1, wherein said organo clay being a natural montmorillonite modified with a quaternary ammonium salt.

6. The crosslinkable composition according to claim 1, wherein said composition comprising from 80 to 98 percent by weight of said crosslinkable polymer, based on the weight of said crosslinkable composition.

7. The crosslinkable composition according to claim 1, wherein said composition comprising from 1 to 10 percent by weight of said scorch inhibiting agent, based on the weight of said crosslinkable composition.

8. The crosslinkable composition according to claim 1, wherein said composition comprising from 1 to 10 percent by weight of said migration inhibiting agent, based on the weight of said crosslinkable composition.

9. The crosslinkable composition according to claim 1, wherein said composition comprising from 80 to 98 percent by weight of said crosslinkable polymer, from 1 to 10 percent by weight of said scorch inhibiting agent, and from 1 to 10 percent by weight of said migration inhibiting agent, based on the weight of said crosslinkable composition.

10. The crosslinkable composition according to claim 1, wherein said exfoliated organo clay comprising one or more high aspect ratio organo clay particles.

11. The crosslinkable composition according to claim 1, wherein said composition further including a free radical initiator.

12. The crosslinkable composition according to claim 11, wherein said free radical initiator being a peroxide.

13. The crosslinkable composition according to claim 12, wherein said peroxide being selected from the group consisting of dialkyl peroxides, diacyl peroxide, and diperoxyketal initiators.

14. A method of reducing scorch inhibitor migration in a crosslinkable composition comprising the steps of:
selecting an crosslinkable polymer;
selecting a scorch inhibiting agent, wherein said scorch inhibiting agent being a polar nitroxide;
selecting a migration inhibiting agent, wherein said migration inhibiting agent being organo clay capable of being exfoliated;
melt blending said scorch inhibiting agent and said migration inhibiting agent into said crosslinkable polymer;
thereby at least partially exfoliating said organo clay into one or more high aspect ratio particles; and
thereby producing said crosslinkable composition having reduced scorch inhibiting agent migration.

15. The method of reducing scorch inhibitor migration in a crosslinkable composition according to claim 14, wherein said crosslinkable polymer being selected from the group consisting of low density polyethylene (LDPE), linear low density polyethylene (LLDPE), high density polyethylene (HDPE), medium density polyethylene (MDPE), ultra-low density polyethylene, chlorinated polyethylene, polypropylene, ethylene propylene copolymer, ethylene-propylene terpolymer, ethylene-propylene-diene monomer (EPDM), ethylene vinyl acetate (EVA), polybutadiene, styrene-acrylonitrile (SAN), acrylonitrile-butadiene-styrene (ABS), silicone rubber, chlorosulfonated polyethylene, fluoroelastomers and combinations thereof.

16. The method of reducing scorch inhibitor migration in a crosslinkable composition according to claim 14, wherein said scorch inhibiting agent being selected from the group consisting of 4-hydroxy-2,2,6,6-tetramethylpiperidin-1-oxyl (4-hydroxy-TEMPO), and 4-oxo-2,2,6,6,tetramethylpiperidine-N-oxyl (4-oxo-Tempo).

17. The method of reducing scorch inhibitor migration in a crosslinkable composition according to claim 14, wherein said exfoliated organo clay having at least 2 fatty acids substitutions.

18. The method of reducing scorch inhibitor migration in a crosslinkable composition according to claim 14, wherein said organo clay being a natural montmorillonite modified with a quaternary ammonium salt.

19. The method of reducing scorch inhibitor migration in a crosslinkable composition according to claim 14, wherein said composition comprising from 80 to 98 percent by weight of said crosslinkable polymer, based on the weight of said crosslinkable composition.

20. The method of reducing scorch inhibitor migration in a crosslinkable composition according to claim 14, wherein said composition comprising from 1 to 10 percent by weight of said scorch inhibiting agent, based on the weight of said crosslinkable composition.

21. The method of reducing scorch inhibitor migration in a crosslinkable composition according to claim 14, wherein said composition comprising from 1 to 10 percent by weight of said exfoliated organo clay, based on the weight of said crosslinkable composition.

22. The method of reducing scorch inhibitor migration in a crosslinkable composition according to claim 14, wherein said composition comprising from 80 to 98 percent by weight of said crosslinkable polymer, from 1 to 10 percent by weight of said scorch inhibiting agent, and from 1 to 10 percent by weight of said exfoliated organo clay, based on the weight of said crosslinkable composition.

23. The method of reducing scorch inhibitor migration in a crosslinkable composition according to claim 14, wherein said method further comprising the steps of:
selecting a free radical initiator; and
melt blending said free radical initiator, said scorch inhibiting agent, and said migration inhibiting agent into said crosslinkable polymer.

24. The method of reducing scorch inhibitor migration in a crosslinkable composition according to claim 14, wherein said composition comprising from 1 to 20 percent by weight of said free radical initiator, based on the weight of said crosslinkable composition.

25. An article comprising the crosslinking reaction product of:
a crosslinkable composition comprising the reaction product of;
a crosslinkable polymer;
a scorch inhibiting agent, wherein said scorch inhibiting agent being a polar scorch inhibiting agent; and
a migration inhibiting agent, wherein said migration inhibiting agent being organo clay capable of being exfoliated.

26. A method of making a crosslinkable composition comprising the steps of:
selecting an crosslinkable polymer;
selecting a scorch inhibiting agent, wherein said scorch inhibiting agent being a polar scorch inhibiting agent;
selecting a migration inhibiting agent, wherein said migration inhibiting agent being organo clay capable of being exfoliated;
melt blending said scorch inhibiting agent and said migration inhibiting agent into said crosslinkable polymer;
thereby at least partially exfoliating said organo clay into one or more high aspect ratio particles; and
thereby producing said crosslinkable composition having reduced scorch inhibiting agent migration.
